(19) United States
(12) Patent Application Publication
(10) Pub. No.: US 2023/0076414 A1
(43) Pub. Date: Mar. 9, 2023

(54) SEAT-BACK HOLDER ASSEMBLY FOR PERSONAL ELECTRONIC DEVICES

(71) Applicant: William J. Boyer, JR., Black Diamond, WA (US)

(72) Inventor: William J. Boyer, JR., Black Diamond, WA (US)

(21) Appl. No.: 17/842,722

(22) Filed: Jun. 16, 2022

Related U.S. Application Data
(63) Continuation of application No. 17/101,172, filed on Nov. 23, 2020, now abandoned.
(60) Provisional application No. 62/940,806, filed on Nov. 26, 2019.

(51) Int. Cl. B60R 7/04

(52) U.S. Cl. CPC B60R 7/043

(57) ABSTRACT

The present technology relates generally to movable personal electronic device (PED) holder assemblies that can be attached to seat-back assemblies mounted on vehicle seats, such as in an airplane, train, bus, or other vehicle. The PED holder assembly can be partially inserted into the seat-back pocket or set on top of a surface and has a receiving portion that extends down from a clip portion. The receiving portion includes legs extending down from the clip, a support portion, and retention shoulders, and is configured to receive and hold onto a PED without need for user involvement after placing the PED in a receiving area. Further, the receiving portion is configured to not impede access to the tray table locking mechanism on a seat-back assembly and is configured to allow the tray table to be moved from a folded-up position to a folded-down position without having to move the PED holder.

### CROSS-REFERENCE TO RELATED APPLICATION(S)

This application is a continuation of U.S. patent application Ser. No. 17/101,172, titled SEAT-BACK HOLDER ASSEMBLY FOR PERSONAL ELECTRONIC DEVICES, filed Nov. 23, 2020, which claims the benefit of and priority to U.S. Provisional Patent Application No. 62/940,806, titled SEAT-BACK HOLDER ASSEMBLY FOR PERSONAL ELECTRONIC DEVICES, filed Nov. 26, 2019, both of which are incorporated herein in their entirety by reference thereto.

### TECHNICAL FIELD

This patent application is generally directed to holders for personal electronic devices, and more particularly to a holder configured to support tablets, smartphones, or other personal electronic devices, that can be attached to an existing seat-back assembly mounted to a seat in a vehicle.

### BACKGROUND

Vehicle passengers make use of a variety of materials and devices to occupy their time during transport. For example, Personal Electronic Devices (PEDs) are commonly used by passengers during transport as a source of entertainment and a means to complete work. A PED can be any type of electronic device that a user can transport and use in a mobile environment, such as a tablet computer, notebook computer, smartphone, electronic book/electronic reader, music device, laptop computer, cellular/personal communication device, audio/video/data recording or playback device, scanning device, messaging device, personal digital assistant (PDA), or similar device. While such devices can be enjoyable and productive to use in transport, it can be difficult to use such PEDs comfortably for extended periods given the limited personal space typically allocated to individual vehicle passengers. Systems have been used to hold PEDs to address this problem, but many of the systems are complex, expensive, unpractical and often require installation of a structural assembly in an obtrusive location that limits space available on the top surface of a tray table when it is deployed, as well as detracting from the comfort of a passenger. The current systems have many drawbacks.

### BRIEF DESCRIPTION OF THE DRAWINGS

Embodiments of the Personal Electronic Device (PED) holder introduced herein may be better understood by referring to the following Detailed Description in conjunction with the accompanying drawings, in which like reference numerals indicate identical or functionally similar elements.

FIG. 1 is an isometric view of a PED holder that can attach to a seat-back assembly, or stand independently on a planer surface, and can receive a PED in accordance with one or more embodiments of the present technology.

FIG. 2 is a side view of the PED holder of FIG. 1, wherein the left-side view is a mirror image of the right-side view.

FIG. 3 is a side view of the PED holder in accordance with another embodiment wherein the assembly is configured with one or more hinge elements that allow the PED holder to be collapsed to a substantially flat position, and wherein the left-side view is a mirror image of the right-side view.

FIG. 4 is a front view of the PED holder of FIG. 1.

FIG. 5 is a top view of the PED holder of FIG. 1.

FIG. 6 is a perspective view of the front of the PED holder of FIG. 1 deployed in an airplane seat-back assembly.

FIG. 7 is a perspective view of the front of the PED holder of FIG. 1 deployed in an airplane seat-back assembly with the tray table assembly folded out.

FIG. 8 is a perspective view of the system according to FIG. 6, wherein the PED holder has a PED supported in the PED holder.

FIG. 9 is a perspective view of the PED holder of FIG. 1 in accordance with one or more embodiments of the present technology, wherein the PED holder is configured to stand independently on a support surface, such as a tray table assembly, and has a PED supported in the PED holder.

FIG. 10 is a front isometric view of an embodiment of the PED holder of the present technology.

FIG. 11 is a rear isometric view of an embodiment of the PED holder of the present technology.

Appendix A includes photographs of a PED holder in accordance with one or more embodiments of the present technology.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to limit the embodiments described. On the contrary, the embodiments are intended to cover all modifications, equivalents, and alternatives falling within the scope of the embodiments.

### DETAILED DESCRIPTION

The present technology generally relates to hands-free personal electronic device (PED) holder assemblies configured for use with various seat-back assemblies mounted on the seat of a vehicle, such as in an airplane, train, bus, or other vehicle. The PED holder assembly can also be free standing on a surface to be used, for example, with tray tables on a seat-back assembly or other planer surfaces.

Various examples of the PED holder introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description. For purposes of simplicity of discussion, the PED holder assembly will be described herein with reference to top and bottom, upper and lower, upwards and downwards, and/or left or right relative to the spatial orientation of the embodiment(s) shown in the figures. It is to be understood that the PED holder assembly, however, can be moved to and used in different spatial orientations without changing the structure of the system.

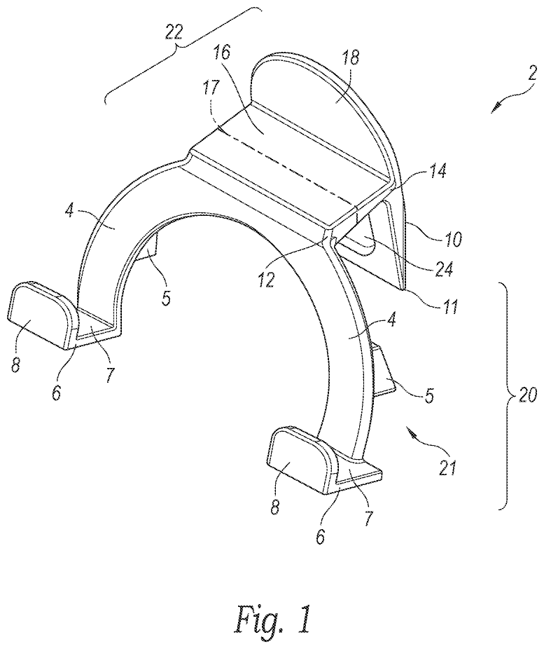

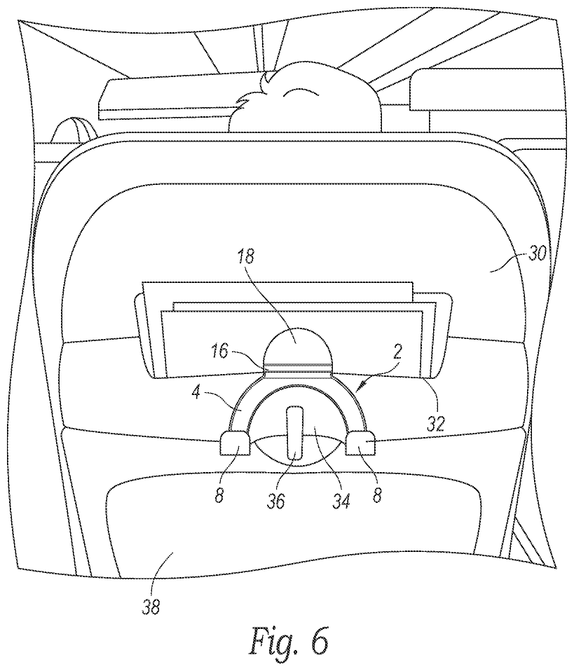

In particular, the PED holder will be described with reference to the front and rear of the PED holder, and the front facing and rear facing directions of the PED. As used herein, the front of the PED holder in the portion of the PED holder a user would see while using and/or installing the device. For example, the retention shoulders 8 (FIG. 1) are at the front of the PED holder. The rear of the PED holder is the opposite portion of the PED holder, farther away from the user. For example, the pocket element is in the rear of the PED holder. Front facing sides are used to define the sides of the PED holder while the PED holder is in use. Rear facing sides are used to discuss the sides of the PED holder that would face the seat-back assembly 30 (FIG. 6) while the PED holder is installed in a seat pocket 32.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

FIG. 1 is an isometric view of a PED holder 2 in accordance with at least one embodiment of the present technology. The PED holder 2 can be mounted in a seat-back assembly 30 (FIG. 6) or be independent (e.g. free-standing, self-supporting, etc.) on a support surface, such as a tray table or other surface, and can be used to removably hold a PED in position for viewing or otherwise using. The PED holder 2 has a receiving portion 20 comprised of spaced-apart arms 4, support portions 6 projecting from free ends of the arms 4, and retention shoulders 8 extending upwardly from the support portions 62 which define a receiving area 21. A PED can be placed in the receiving area 21 with the PED's display screen facing the user at an angle selected for viewing. When a PED is placed in the holder 2, an edge of the PED is positioned in the receiving area 21 and atop the support portions 6 with the PED leaning against the arms 4. The retention shoulders 8 extend upwardly from the front end of the support portion 6 and can act to prevent the PED from sliding forwardly out of the receiving area 21. In at least one embodiment, the retention shoulders 8 extend upwardly far enough to retain the PED without blocking or covering any substantive portion of the PED's screen.

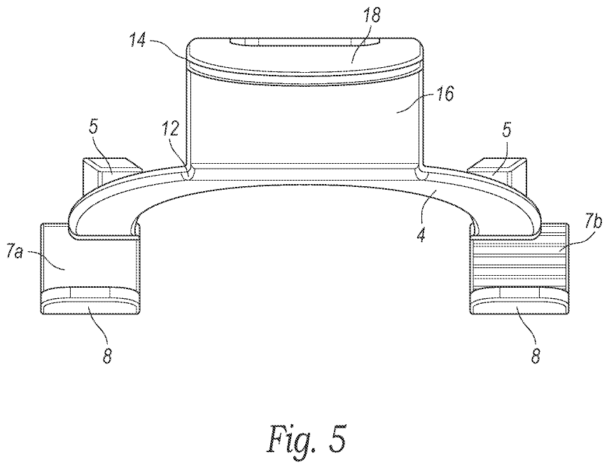

In one embodiment, the support portion 6 is covered by a layer 7 that minimizes PED movement on the support portion 6, thereby reducing risk of inadvertent movement of the PED within the holder 2. The layer 7 may be a high friction material, such as a rubber or foam, designed to reduce the amount the PED slides when resting on the layer 7. In some embodiments, the layer 7 can be a relatively soft material to protect the edge of the PED when being placed in the PED holder 2 or during any unexpected vehicle turbulence or other impact loads. Further, the layer 7 can comprise a smooth surface 7a (shown in FIG. 5) or contain a traction pattern 7b that, among other things, further limits the movement of the PED.

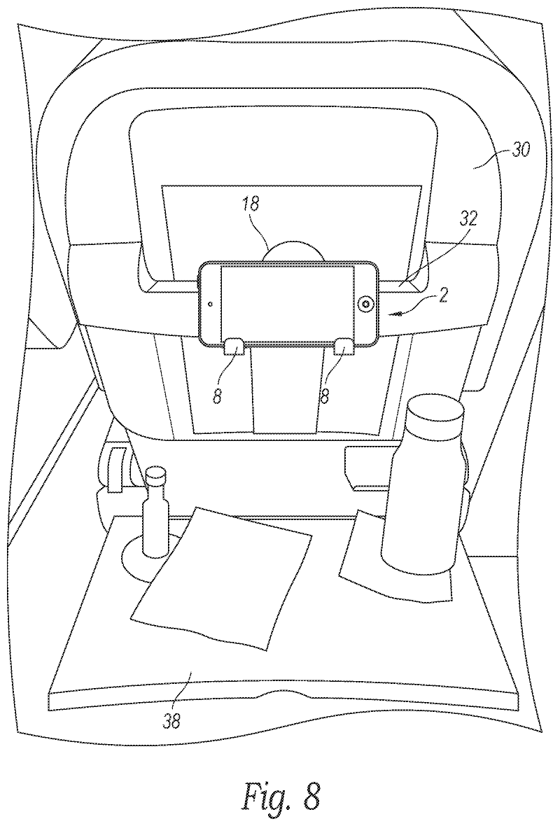

The PED holder 2 further comprises a seat clip portion 22 connected to the upper portion of the arms 4. A hanger element 16 is connected to the arms 4 at a front joint 12 and extends laterally relative to the arms 4. A pocket element 10 is connected to the hanger element 16 at a rear joint 14 and extends downwardly relative to the hanger element 16. A high-back portion 18 is connected to the hanger element 16 at the rear joint 14 and extends upwardly relative to the hanger element 16. The high-back portion 18 can be configured to act as a handle while the PED holder 2 is being installed into a seat pocket 32 (FIG. 6) or moved to a support surface, such as a tray table 38. The seat clip portion 22 is configured as a static c-shaped clip, and the hanger element is configured to engage and hang on the upper edge of a seat pocket 32, while the arms 4 and the whole pocket element 10 prevent the clip portion 22 from sliding, rocking, and/or falling off the upper edge of the seat pocket 32. An example of an installed PED holder 2 is shown in FIG. 8, with the pocket element 10 inserted into a seat pocket 32, the hanger element 16 resting on the upper edge of the seat pocket 32, and the arms 4 engaging the seat-back assembly 30. When a PED is placed in the receiving area 21, the load is primarily carried by the hanger element 16 pushing down on the upper edge of the seat pocket 32.

In the illustrated embodiment, pocket element 10 has an open center portion 24, which helps reduce the weight of the PED holder 2. In other embodiments the pocket element 10 can be a solid component or can have areas with reduced thickness to decrease the weight the PED holder 2.

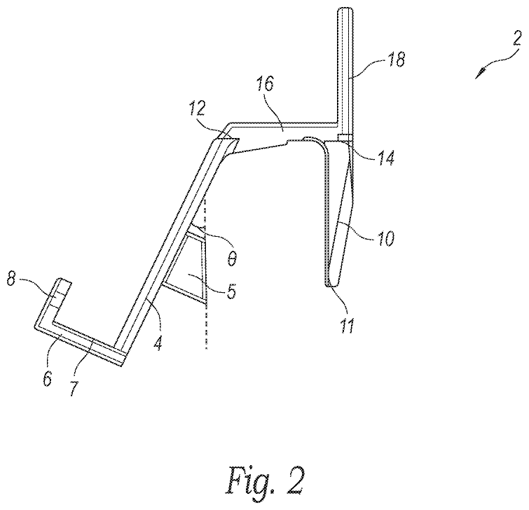

FIG. 2 is a side view of the PED holder 2. In some embodiments, the seat clip portion 22 further comprises stand offs 5 extending from the rear side of the arms 4. The rear surface of the stand offs 5 have a slope configured to engage the seat-back assembly, thereby supporting the arms 4 at a selected an angle 8. Angle 8 can be chosen to orient the receiving portion and an installed PED for better viewing and/or to improve the PED holder's 2 ability to tilt and retain a PED. The vertical position of the stand offs 5 relative to the arms can also be selected during manufacture. For instance, PED holders 2 can be manufactured with the stand offs 5 located on the lower portion of the arms 4, or on the upper portion of the arms 4, or in a middle portion of the arms 4. The placement of the stand offs 5 can be selected based on manufacturing considerations, improving the hanging stability, and/or other considerations.

In the illustrated embodiment, the pocket element 10 has a wedged shape that tapers toward the tip 11 of the pocket element 10, and the tip 11 is rounded. These features allow the pocket element 10 to slide easily in and out of a seat pocket 32 (FIG. 6), particularly when the seat pocket 32 contains items, such as magazines, safety cards, sickness bags, etc. The wedge-shaped pocket element 10 can facilitate a gradual application of force against seat pocket 32 contents as the PED holder 2 is being installed, so as to further reduce snags and jams during installment of the PED holder 2 in the seat pocket 32.

In the embodiment illustrated in FIG. 2, the PED holder 2 is comprised of a single molded material with the components of the holder 2 being integrally connected to each other. In other embodiments, some or all of the components of the holder 2 can be separate pieces fastened together during assembly in the manufacture process.

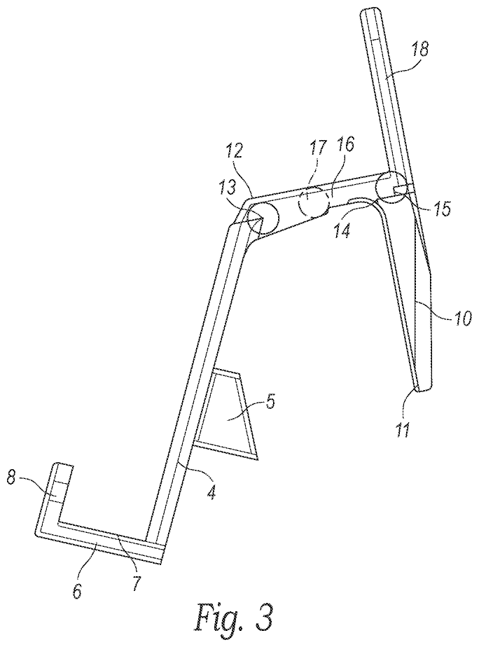

FIG. 3 is a side view of the PED holder 2 in accordance with another embodiment of the present technology, in which the assembly is configured with one or more hinge elements 13 and 15 that allow the PED holder 2 to be collapsed to a generally flattened position. In this embodiment, the front joint 12 is configured to include a hinge element 13 that allows the hanger element 16 to pivot relative to the arms 4; and the rear joint 14 is configured to include a hinge element 15 that allows the pocket element 10 and high-back portion 18 to pivot relative to the hinge portion. In another embodiment, the hanger element 16 includes a central hinge element 17, shown in phantom lines that can be the only hinge or that can be combined with one or both of the front or rear hinges 13 and/or 15, so as to allow the pocket element to fold in a generally flat configuration. The hinge elements 13, 15, and/or 17 allow the hanger element 16 and pocket element 10 to be movable between a folded and unfolded position, wherein the hinge elements 13, 15, and/or 17 limit movement away from the folded position and past the unfolded position. In at least one embodiment the hanger element 16 and/or the hinge elements 13, 15, and/or 17 can have retention members configured to releasably retain the hanger element 16 in the folded and/or unfolded positions. The pivoting permitted by the hinge elements 13, 15, and/or 17 can allow the hanger element 16 and pocket element 10 to pivot or fold to a position substantially in alignment with the arms 4. This allows the PED holder 2 to be easily and conveniently stored in, as an example, the seat pocket 32 (FIG. 6). The hinged configurations also help reduce the volume of the PED holders during storage and/or shipping of the units. In one embodiment, the hinge elements 13, 15, and/or 17 are comprised of a pin design that allows the receiving portion 20, hanger element 16, the high-back portion 18, and the pocket element 10 to be manufactured separately then connected at the hinge elements 13, 15, and/or 17.

In various other embodiments, the PED holder 2 can be configured with a different number of hinge elements. For example, the PED holder 2 or can be configured with more than two hinge elements to, for example, allow the PED holder 2 to fold between deployed and stowed positions. Alternatively, the PED holder 2 can be configured with only a single hinge element at either the mid portion of the hanger element 16 or adjacent to the front joint 12 or rear joint 14 to, for example, achieve some of the benefits of folding without overcomplicating the system; or the PED holder 2 can be configured with no hinge elements as illustrated in FIG. 2.

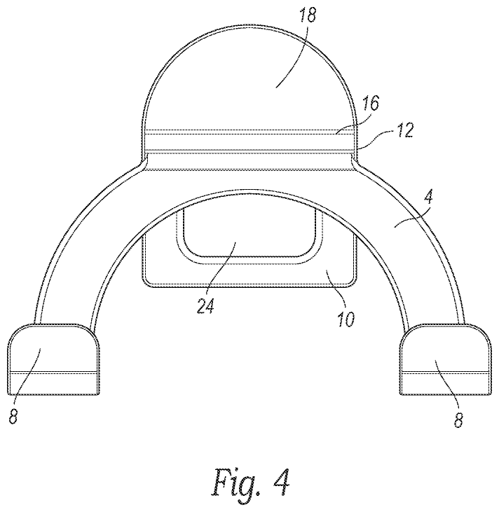

FIG. 4 is a front view of the PED holder 2. The illustrated PED holder 2 has multiple front surfaces, including: one on each of the retention shoulders 8, one on the arms 4, one on the high-back portion 18, and one on the upper surface of the hanger element 16. In one embodiment, the front surfaces are flat surfaces with no bumps, protrusions, or displays. However, this is merely an example. If desired, the front surfaces may have a border or bezel formed around the perimeter of the surfaces surrounding areas configured to receive decals or removable placards that include instructions on using PED holder 2. The front surfaces can also be used to receive and display images, such as advertisements, messages, visuals, etc., viewable by the user. The front surfaces can be configured such that the images cover the entire surface, or such that the images are surrounded by a bevel or protrusions. In other embodiments, the PED holder 2 may have either more or less of surfaces corresponding to the front portions of the elements in that embodiment. For example, the PED holder 2 may be manufactured without the high-back portion 18 and therefore without that additional front surface and/or handle for installation. In another embodiment, the front surfaces and/or the rear may have gripping elements that allow a user to easily grasp and hold the PED holder 2 such as when installing the PED holder 2 in a seat-back assembly.

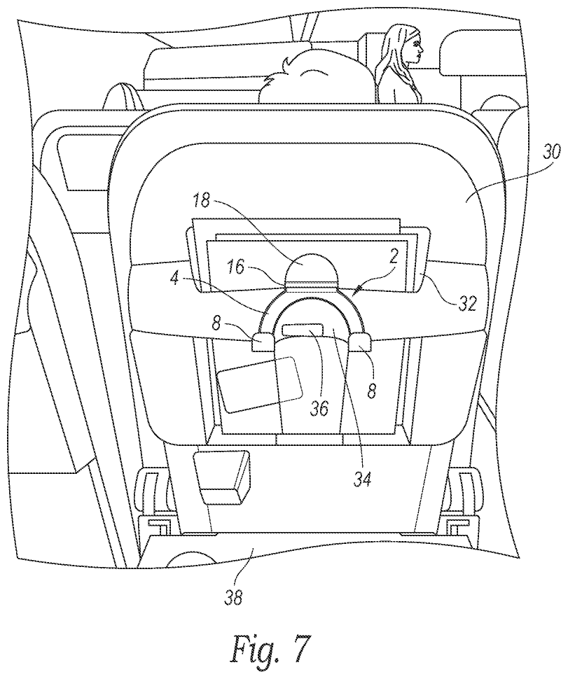

FIGS. 6 and 7 provide perspective views of the PED holder 2 deployed in an airplane seat-back assembly 30. The seat-back assembly 30 comprises a seat pocket 32, which can store magazines, safety cards, sickness bags, etc.; a tray table 38, which can be in a folded-up or a folded-down position; a locking mechanism 34, which can be turned to hold the tray table 38 in the folded-up position or allow the tray table 38 to be moved into the folded-down position; and a pathway 36 in the assembly 30 for the locking mechanism 34 to turn. More details on the layout and function of the assembly 30 are well-known in the art and not described to avoid unnecessarily obscuring the description of various embodiments of the disclosure.

FIGS. 6 and 7 help illustrate additional features of the arms 4. In one embodiment, the free ends of the arms 4 are spaced apart horizontally to define a space for the tray table locking mechanism 34, such that the arms 4 do not impede a user's access to the locking mechanism 34, nor do they disrupt the locking mechanism 34 by impeding the pathway 36. Rather, the arms 4 extend such that they clear the pathway 34 laterally and vertically. This clearance of the pathway 36 is balanced against the need for the arms 4 to be close enough together to support a relatively short PED in the PED holder 2. In one preferred embodiment, the arms 4 have a curved shape, such as a wishbone or rainbow shape that closely traces the circumference of the pathway 36. Further, the arms 4 are sized so as to not interfere with movement of the tray table 38 between a stowed position (shown in FIG. 6) to a lowered position (shown in FIG. 7).

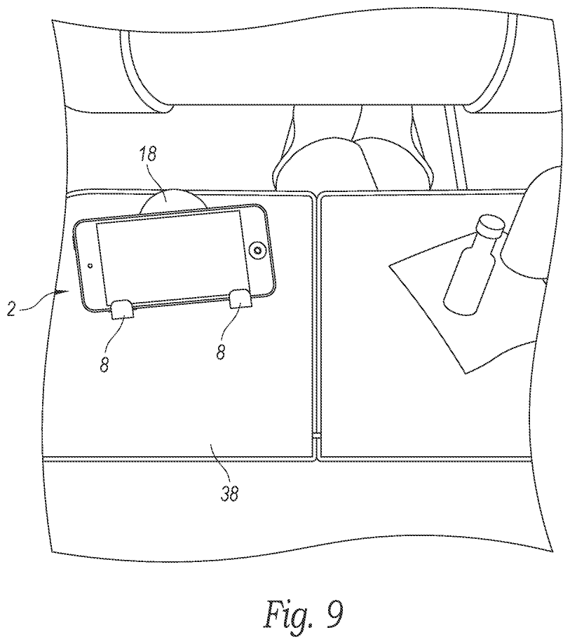

FIG. 8 is a perspective view of the PED holder 2 on a seatback pocket and supporting a PED while in use, with the tray table 38 in the lowered position. In this position, the PED holder 2 allows a user to watch or otherwise interact with the PED without taking up room on the tray table 38. FIG. 9 is a perspective view of the PED holder 2 shown removed from the seatback pocket 32 and resting on the tray table 38. In this position, the PED holder 2 acts as a stand that supports the PED at an angle for viewing without the need for the user to hold the PED. In the illustrated embodiment, the arms 4 and the pocket element 10 define a three-point support that allows the PED holder 2 to be placed on a tray table 38 or other support surface and independently hold a PED at an angle convenient for the user's viewing.

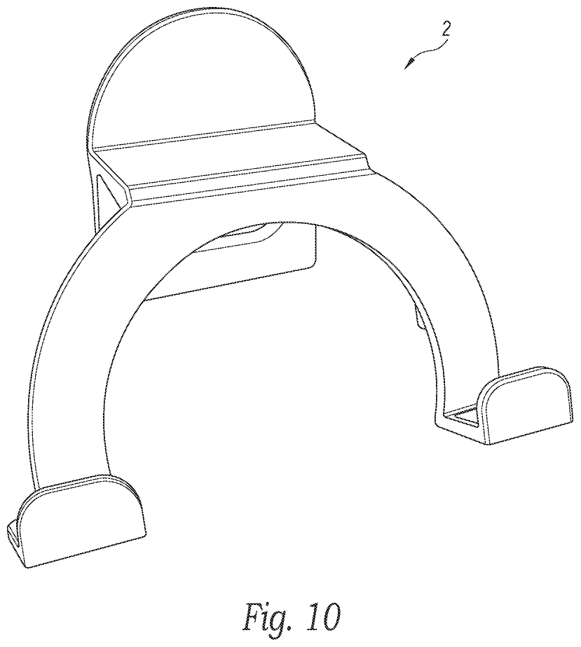

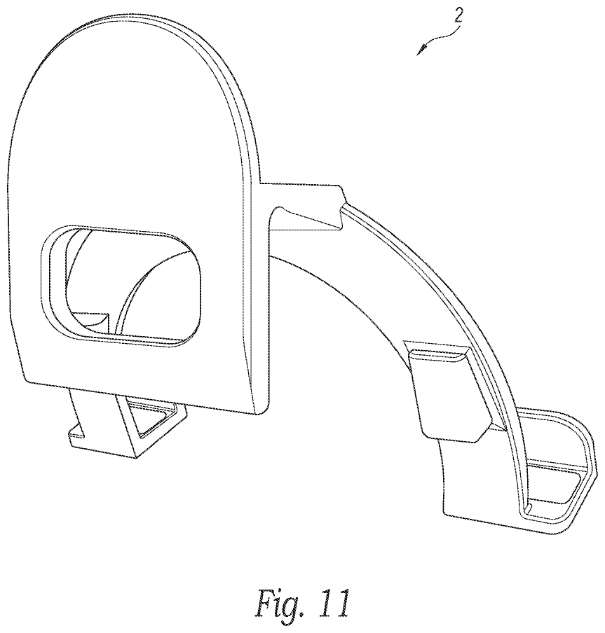

FIGS. 10 and 11 are isometric views of the PED holder 2 providing additional views of the front and rear of the PED holder 2, respectively.

FIGS. 1-11 of the illustrated embodiments show a seat-back holder assembly for personal electronic devices with a novel ornamental design. Other embodiments can have other shapes, sizes, and/or ornamental designs while still embodying the features of the present technology.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

1.-4. (canceled)

5. A Personal Electronic Device (PED) holder mountable to a seat-back assembly, the PED holder comprising receiving portion having spaced-apart arms, a seat clip portion connected to upper portions of the arms, support portions projecting from bottom, free ends of the arms, and retention shoulders extending upwardly from the support portions that define a receiving area configured to removable receive a PED with an edge of the PED is positioned in the receiving area and atop the support portions with the PED leaning against the arms, wherein the retention shoulders are positioned to prevent the PED from sliding of the receiving area.

6. The PED holder of claim 5, further comprising a hanger element connected to the upper portions of the arms at a front joint and extends laterally relative to the arms, and a pocket element is connected to the hanger element at a rear joint, wherein the pocket element extends downwardly relative to the hanger element.

7. The PED holder of claim 6, further comprising a high-back portion connected to the hanger element at the rear joint and extending upwardly relative to the hanger element, wherein the high-back portion is configured to be grasped while the PED holder is being installed into a seat pocket.

8. The PED holder of claim 6, wherein the pocket element has an open center portion.

9. The PED holder of claim 5 wherein the seat clip portion has stand offs extending from the arms, and a rear surface of the stand offs have a slope configured to engage the seat-back assembly to support the arms at a selected an angle relative to the seat-back assembly.

10. The PED holder of claim 5, wherein the holder is formed of a single molded material with the components of the holder being integrally connected to each other.

11. The PED holder of claim 6 wherein the front joint has a first hinge element that allows the hanger element to pivot relative to the arms, and the rear joint has a second hinge element configured to allow the pocket element to pivot relative to the hinge portion.
